(19) United States
(12) Patent Application Publication
(10) Pub. No.: US 2003/0128784 A1
(43) Pub. Date: Jul. 10, 2003

(54) Semiconductor integrated circuit

(75) Inventor: Tsutomu Takabayashi, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/144,146

(22) Filed: May 14, 2002

(30) Foreign Application Priority Data
Jan. 8, 2002 (JP) 2002-001271

(51) Int. Cl. H04L 7/00

(52) U.S. Cl. 375/356

(57) ABSTRACT

The semiconductor integrated circuit comprises a plurality of delay elements that delay in a stepped manner a master clock signal generated internally to obtain a plurality of clock signals with differing phases, and a multiplexer which sequentially selects any one of the clock signals with differing phases at a time and outputs the selected signal to a plurality of receiver integrated circuits through a common clock line.

### FIELD OF THE INVENTION

This invention relates to semiconductor integrated circuits which particularly output data signals and clock signals.

### BACKGROUND OF THE INVENTION

In data transmission system of electronic gadgets data signals and clock signals are transmitted from one semiconductor integrated circuit to a plurality of semiconductor integrated circuits through a common clock signal line and data signal line. Examples of such a data transmission system are shown in FIG. 9, FIG. 12, and FIG. 14. Outline of these data transmission systems is explained below while referring to FIG. 9 through FIG. 15.

FIG. 9 shows a schematic diagram of the first example of the data transmission system used in electronic equipment having multiple semiconductor integrated circuits. This data transmission system includes a semiconductor integrated circuit for output (OUTIC) 101 and a plurality of receiver semiconductor integrated circuits (IC) 104, 105, 106, and 107. The IC's 104, 105, 106, and 107 are connected in parallel to the OUTIC 101 via a data line 102 and a clock line 103. IC's 104, 105, 106, and 107 may be placed on the substrate on which the OUTIC 101 is placed or the IC's and the OUTIC may be placed on respectively different substrates.

FIG. 10 explains how the data transmission takes place in the data transmission system shown in FIG. 9. FIG. 10 shows an instance where the OUTIC 101 sequentially sends a data signal (DATA) of 100 units to the respective data areas of the IC's 104, 105, 106, and 107. In this data transmission system 100, as shown in the FIG. 10, the OUTIC 101 sends the clock signal (CLK) to the clock line 103 and sends the data signal (DATA) for each IC to data line 102. Each IC gets the data signal of the corresponding data area from data line 102 according to the clock signal on clock line 103.

Data line 102 and clock line 103 bear the substrate load or the input load of each IC. Even if the data line 102 and the clock line 103 are placed on an identical substrate, their impedance varies according to the location. As data line 102 and clock line 103 are connected to the substrate through the connector the impedance is reflected in the transmission circuit. Also, cross talk (interference) occurs when the number of data bits increases. Moreover, the delay is different in data signal and clock signal, as there is a difference in the frequency of these two signals. As a result, as shown in FIG. 11, the relative timing of data signal and clock signal of the input terminal of each IC differs as per the distance of the IC from the OUTIC 101.

FIG. 11 is the time chart, which explains the relationship between data signals and clock signals input in the receiver semiconductor integrated circuit (IC) shown in FIG. 9.

(1) Regarding the input terminal of the input terminal of the IC 104: Since the IC 104 is located very close to the OUTIC 101, there is very little transmission delay. As a result, the timing of the data signal and the clock signal at the input terminal of the IC 104 is within the constraint of the IC 104.

(2) Regarding the input terminal of the IC 106: As the IC 106 is located at a position that is the second far most from the OUTIC 101, transmission delay 131 becomes significant and a time lag is observed in the setup time 132 of the data signal, the hold time 133 thereafter, and the clock signal. This time lag is close to the constraint limits of the IC 106.

(3) Regarding the input terminal of the IC 107: A considerable transmission delay 134 occurs in the input terminal of the IC 107, which is the farthest from the OUTIC 101. A time lag is observed in the setup time 135 of the data signal, the hold time 136 thereafter, and the clock signal. This time lag exceeds the constraint limits of the IC 107.

FIG. 12 shows a schematic diagram of the second example of the data transmission system used in electronic equipment having multiple semiconductor integrated circuits. This data transmission system 140 comprises, corresponding to the clock line 103 shown in FIG. 9, a first clock line 141 and a second clock line 142. The first clock line 141 transmits a first clock signal (CLK1) to the IC's 104 and 105. The second clock line 142 transmits a second clock signal (CLK2) to the IC's 106 and 107. Thus the load on the clock line is reduced. Moreover, as the phases of the first clock signal (CLK1) and the second clock signal (CLK2) can be made different, the relationship of the setup time, the hold time and the clock signal can be maintained within the constraint of each IC, as shown in FIG. 13.

FIG. 13 is a time chart, which explains the relationship between data signals and clock signals input in the receiver semiconductor integrated circuit (IC) shown in FIG. 12.

(1) Regarding the input terminal of the IC 104: The first clock signal (CLK1) is input in the input terminal of the IC 104 after a pre-set delay 152. No lag is seen between the data signal and the first clock signal (CLK1).

(2) Regarding the input terminal of the IC 107: The second clock signal (CLK2) is input in the input terminal of the IC 107 with a pre-set delay 153. The relationship between setup time 154, hold time 155 and the second clock signal (CLK2) is within the constraint of the IC 107.

(3) Regarding the output terminal of the OUTIC 101: The OUTIC 101 transmits the second clock signal (CLK2) after a pre-set delay 151 after transmitting the first clock signal (CLK1).

FIG. 14 is a block diagram of the third example of the data transmission system used in electronic equipment having multiple semiconductor integrated circuits. The data transmission system 160 comprises a delay circuit 161. This delay circuit 161 is provided, on the clock line 103, between the IC 105 and the IC 106. Clock signal before it is delayed is referred as the first clock signal (CLK1), and clock signal after it is delayed is referred as the second clock signal (CLK2).

The transition period of the wave forms in the input terminal of the IC 104 with a short wiring circuit may get prolonged due to reflection or interference (cross talk) of the data signals when the number of data bits is large. Therefore, in the data transmission system 160, when it is required to have the delay of clock signal at the input terminal of the IC 104 greater than that of clock signal of the IC 107 input terminal, the necessary delay time required in input terminal is ensured and only after that the clock signal is transmitted to the IC 107. As a result, the timing relationship at the input terminal of the IC 107 is maintained, as shown in FIG. 15.

FIG. 15 is a time chart, which explains the relationship between data signals and clock signals input in receiver semiconductor integrated circuit (IC 107) shown in FIG. 14. In FIG. 15, the first clock signal (CLK1) is entered in the input terminal of the IC 107 in the absence of the delay circuit 161. Therefore, the relationship between setup time 162, hold time 163 and the first clock signal (CLK1) is not within the constraint limits of the IC 107. However, when the delay circuit 161 is provided, the second clock signal (CLK2) after delay time 164 is elapsed, is input in the input terminal of the IC 107. Therefore, the relationship between the setup time 162, the hold time 165 and the second clock signal (CLK2) falls within the constraint limits of the IC 107.

As mentioned above, in an electronic equipment, when a data transmission system is set up for transmission of a data signal and a clock signal from one semiconductor integrated circuit to the plurality of semiconductor integrated circuits connected in parallel via a common data line and clock line, the load increases when the number of receiver semiconductor integrated circuits is increased in the structure shown in FIG. 9. Moreover, there may arise disturbance of waveform of data signals and clock signals at the input terminal of the receiver semiconductor integrated circuit. Because of this the relative timing of data signals and clock signals may not satisfy the constraint of receiver semiconductor integrated circuit.

Therefore, normally, to reduce the load, the number of the clock lines is increased as shown in FIG. 12, or phase adjustment is carried out by providing the delay circuit as shown in FIG. 14. However, if the substrate surface is limited, providing a plurality of clock lines may not be possible. Further, although it is possible to delay the clock signal with the delay circuit, the converse action of speeding up the clock signal is not possible. Again, providing the delay circuit will increase the cost. To conform to today's trend of small and slim gadgets, the excessive wiring and elements need to be avoided.

### SUMMARY OF THE INVENTION

It is an object of this invention to provide a semiconductor integrated circuit which adjusts the relative timings of data signals and clock signals reaching the receiver semiconductor integrated circuit by changing the phase of the transmitted clock signals.

The semiconductor integrated circuit according to one aspect of this invention transmits clock signals and data signals to a plurality of receiver semiconductor integrated circuits through a common clock signal line and a data signal line. This semiconductor integrated circuit comprises a phase changing unit which supplies clock signals with differing phases to each of the receiver semiconductor integrated circuits.

The semiconductor integrated circuit according to another aspect of this invention transmits clock signals and data signals to a plurality of receiver semiconductor integrated circuits through a common clock signal line and a data signal line. This semiconductor integrated circuit comprises a group phase changing unit which supplies clock signals with differing phases to each group of receiver semiconductor integrated circuits, wherein the group of receiver semiconductor integrated circuits including a specific number of the receiver semiconductor integrated circuits.

The semiconductor integrated circuit according to still another aspect of this invention transmits clock signals and data signals to a plurality of receiver semiconductor integrated circuits through a common clock signal line and a data signal line. This semiconductor integrated circuit comprises a phase changing unit which supplies clock signals with differing phases to each of the receiver semiconductor integrated circuits, and a group phase changing unit which supplies the clock signals with differing phases to each group of receiver semiconductor integrated circuits, wherein the group of receiver semiconductor integrated circuits including a specific number of the receiver semiconductor integrated circuits.

Other objects and features of this invention will become apparent from the following description with reference to the accompanying drawings.

### BRIEF DESCRIPTION OF THE DRAWINGS

FIG. 1 is a block diagram of data transmission system of the first embodiment of the semiconductor integrated circuit,

FIG. 2 is a block diagram of first embodiment of the semiconductor integrated circuit (OUTIC),

FIG. 3 is the first time chart explaining the relationship between the clock signals generated in the semiconductor integrated circuit shown in FIG. 2, output signals and the selected signals,

FIG. 4 is a time chart explaining the relationship between data signals and the clock signals input in the semiconductor integrated circuit (IC) shown in FIG. 1,

FIG. 5 is the second time chart explaining the relationship between the clock signals generated in the semiconductor integrated circuit shown in FIG. 2, output signals and the selected signals,

FIG. 6 is a block diagram of data transmission system of the second embodiment of the semiconductor integrated circuit,

FIG. 7 is the first time chart explaining the relationship between the clock signals generated in the semiconductor integrated circuit shown in FIG. 6, output signals and the selected signals,

FIG. 8 is the second time chart explaining the relationship between the clock signals generated in the semiconductor integrated circuit shown in FIG. 6, output signals and the selected signals,

FIG. 9 is a block diagram of the first example of a data transmission system used in an electronic gadget involving several semiconductor integrated circuits,

FIG. 10 is a drawing showing data transmission process in the data transmission system shown in FIG. 9,

FIG. 11 is a time chart explaining the relationship between the data signals and the clock signals input in the receiver semiconductor integrated circuits shown in FIG. 9,

FIG. 12 is a block diagram of the second example of a data transmission system used in an electronic gadget involving several semiconductor integrated circuits,

FIG. 13 is a time chart explaining the relationship between the data signals and the clock signals input in the receiver semiconductor integrated circuits shown in FIG. 12,

FIG. 14 is a block diagram of the third example of a data transmission system used in an electronic gadget involving several semiconductor integrated circuits, and

FIG. 15 is a time chart explaining the relationship between the data input in the receiver semiconductor integrated circuits shown in FIG. 14 and the clock signals.

### DETAILED DESCRIPTIONS

The embodiments of the semiconductor integrated circuit according to this invention are explained below in detail with the help of the accompanying drawings.

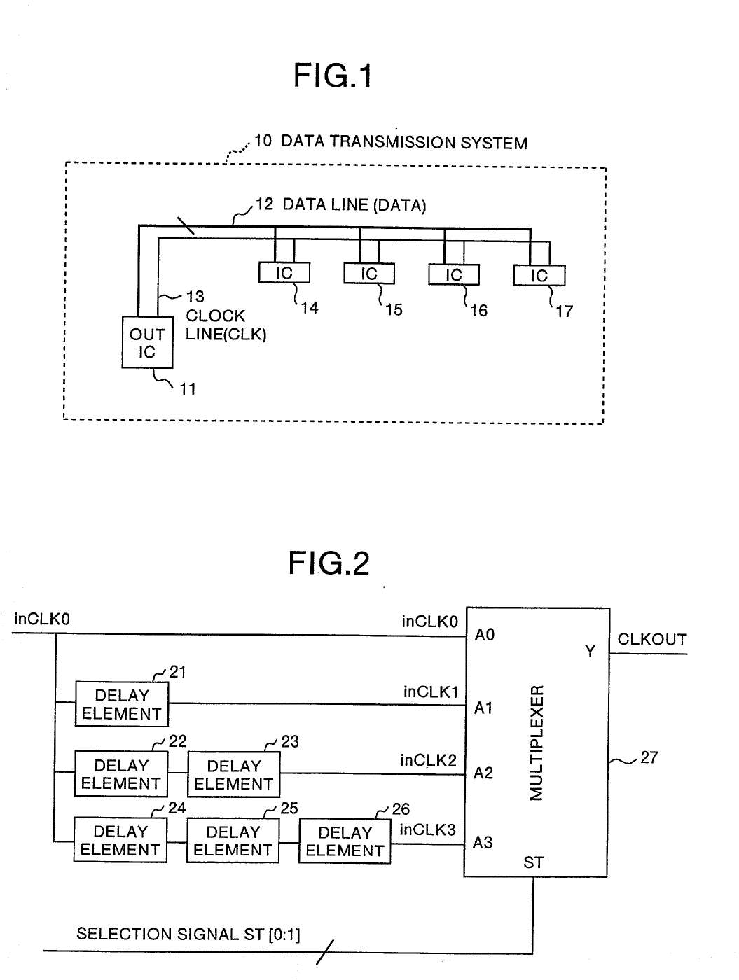

FIG. 1 is a block diagram of the data transmission system in the semiconductor integrated circuit according to the first embodiment of the present invention. This data transmission system 10 comprises a semiconductor integrated circuit for output (OUTIC) 11 and a plurality of receiver semiconductor integrated circuits (IC) 14, 15, 16, and 17. The IC's 14, 15, 16, and 17 are connected in parallel to the OUTIC 11 through a data line 12 and a clock line 13. IC's 14, 15, 16, and 17 may be placed on the substrate on which the OUTIC 11 is placed or the IC's and the OUTIC may be placed on respectively different substrates.

In this data transmission system 10, the OUTIC 11 outputs a clock signal (CLK) to the clock line 13 and outputs a data signal (DATA) for each IC to the data line 12 by their respective data area. Each IC, according to the clock signals (CLK) from the clock line 13, fetches the corresponding data signals (DATA) from data line 12.

The OUTIC 11 in the first embodiment is provided with a mechanism for changing the phase of the clock signals (CLK), output to the clock line 13, for each IC and enables adjustment of relative time in which the data signals and clock signals reach the IC's 14, 15, 16, and 17.

FIG. 2 is a block diagram of the OUTIC 11 shown in FIG. 1. The OUTIC 11 comprises a plurality of delay elements 21-26 and a multiplexer 27. The selection signal S[0:1] is input into the multiplexer 27 from outside.

Delay elements 21-26 have an identical structure and they delay the input clock signal by a unit time and output the delayed clock signals. Delay elements 21-26 are placed in such a way that a master clock signal (inCLK0) that is generated internally is delayed in a stepped manner and a plurality of clock signals with differing phases are generated from the master clock signal. FIG. 2 shows a case in which the delay elements 21-26 are placed in such a way that three clock signals with differing phases are generated.

In other words, in FIG. 2, the delay element 21 outputs the first clock signal (inCLK1), which is the master clock signal (inCLK0) delayed by a unit time, to the multiplexer 27. Delay elements 22 and 23 output the second clock signal (inCLK2), which is the master clock signal (inCLK0) delayed in two steps of one unit time each, to the multiplexer 27. Delay elements 24, 25, and 26 output the third clock signal (inCLK3), which is the master clock signal (inCLK0) delayed in three steps of one unit time each, to the multiplexer 27.

The multiplexer 27 has a terminal A0 where the master clock signal (inCLK0) is input, a terminal A1 where the first clock signal (inCLK1) is input, a terminal A2 where the second clock signal (inCLK2) is input, a terminal A3 where the third clock signal (inCLK3) is input, a selector terminal ST where the selection signal S[0:1] is input from outside, and a terminal Y from where an output clock signal (CLKOUT) is output.

In the multiplexer 27, one clock signal out of the clock signals received at the input terminals A0, A1, A2, and A3 is selected based on the contents of selection signal S[0:1]. This selected clock signal is transmitted from output terminal Y to the corresponding IC in the preset time of the data area. Thus, four types of clock signals with differing phases can be output from output terminal Y.

It is assumed here that the selection signal S[0:1] is made of 2 bits. That is to say, in the multiplexer 27, the master clock signal (inCLK0) received at the terminal A0 is selected when the value of the selection signal S[0:1] is 0, the first clock signal (inCLK1) received at the terminal A1 is selected when the value of the selection signal S[0:1] is 1, the second clock signal (inCLK2) received at the terminal A2 is selected when the value of the selection signal S[0:1] is 2, and the third clock signal (inCLK3) received at the terminal A3 is selected when the value of the selection signal S[0:1] is 3.

Although not shown in the figure, when the number of data for each IC is fixed, depending on the counters, a circuit can be built that generates the selection signal [0:1]. Alternately, if the configuration is such that each IC transmits a data enable signal to the OUTIC 11, then a circuit can be built that generates the selection signal [0:1] based on these data enable signals. Similarly, if the configuration is such that each IC requires a data reception start signal or data enable signal, then a circuit can be built that generates the selection signal [0:1] based on the data reception start signal or the data enable signal.

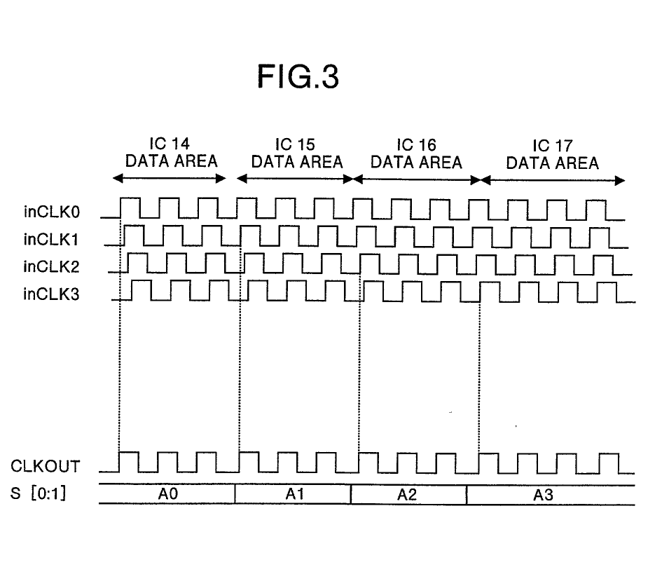

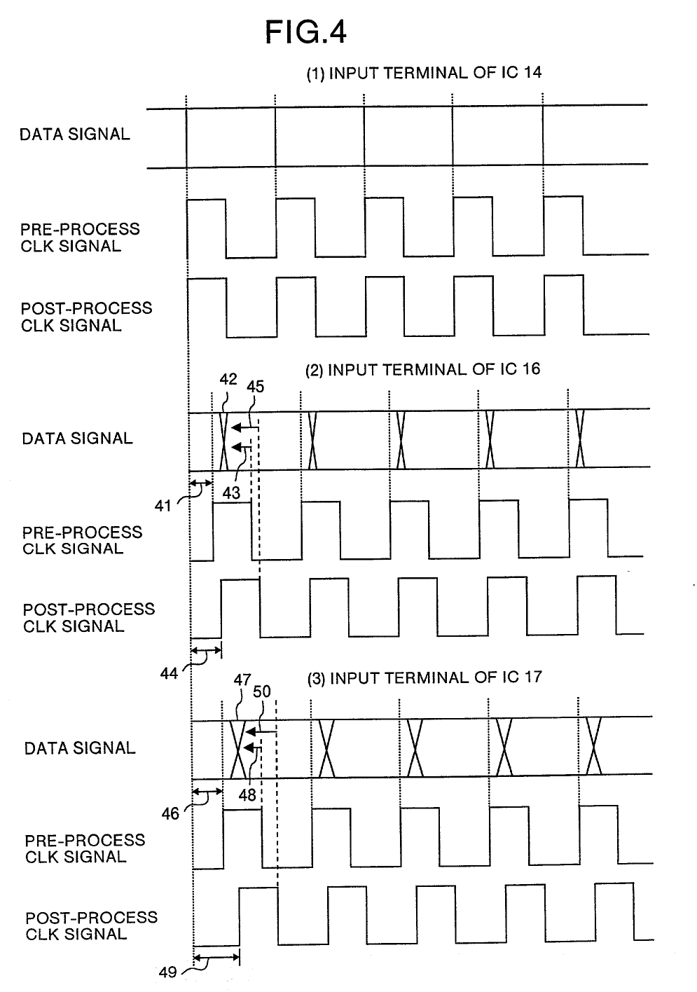

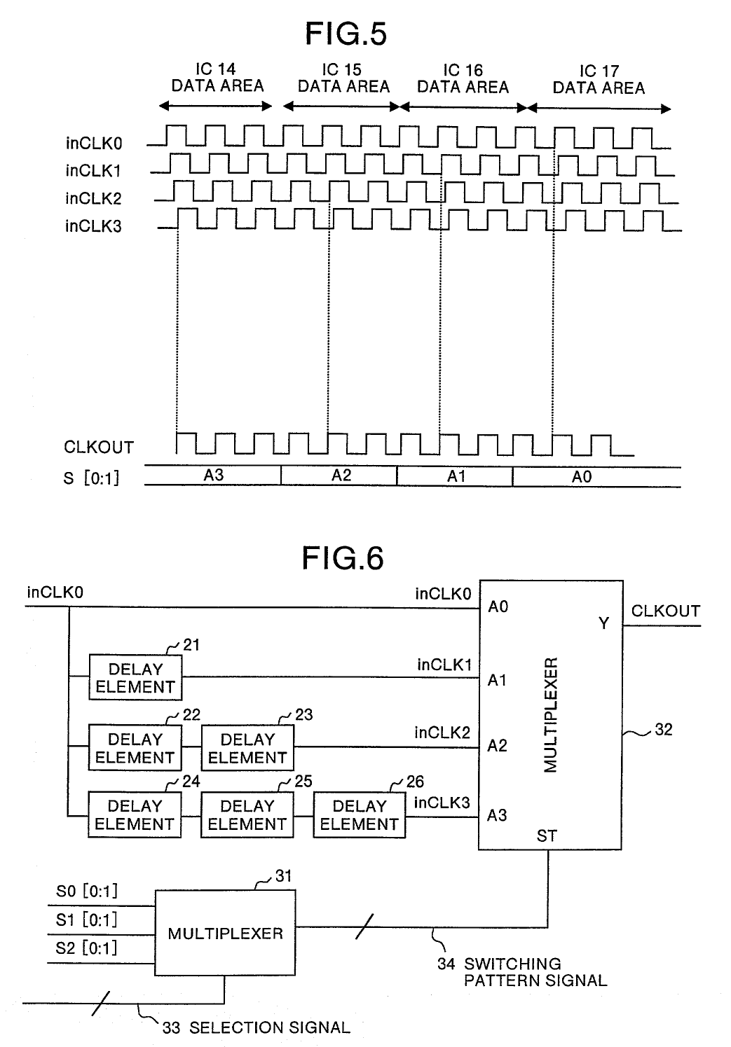

The operation of the data transmission system is explained below with reference to FIG. 1 to FIG. 5. FIG. 3 is the first time chart explaining the relationship between the clock signals generated in the OUTIC 11 shown in FIG. 2, the signal selected and output from the multiplexer 27. FIG. 4 is the time chart, explaining the relationship between the data signals input in the IC's shown in FIG. 1 and the clock signals. FIG. 5 is the second time chart explaining the relationship between the clock signals generated in the OUTIC11 shown in FIG. 2, the signal selected and output from the multiplexer 27.

In FIG. 3, inCLK0 is the master clock signal generated internally. inCLK1 is the first clock signal obtained by delaying the master clock signal by the delay element 21 by one time unit. inCLK2 is the second clock signal obtained by delaying the master clock signal (incCLK0) by the delay elements 22 and 23 by two time units. inCLK3 is the third clock signal obtained by delaying the master clock signal (incCLK0) by the delay elements 24, 25 and 26 by three time units. Thus, these clock signals with these four different phases are input into the multiplexer 27.

The master clock signal (inCLK0) is transmitted to the IC 14, the first clock signal (inCLK1) is transmitted to the IC 15, the second clock signal (inCLK2) is transmitted to the IC 16, and the third clock signal (inCLK3) is transmitted to the IC 17.

The value of the selection signal S[0:1] changes to 0 corresponding to the data area of the IC 14, 1 corresponding to the data area of the IC 15, 2 corresponding to the data area of the IC 16, and 3 corresponding to the data area of the IC 17. The selection signal S[0:1] of appropriate value is input into the selector terminal ST of the multiplexer 27. As a result, the multiplexer 27 selects a signal in the order of the signal input into the terminals A0, A1, A2, A3 sequentially. Thus, a clock signal corresponding to the selected signal is sequentially output as the output clock signals (CLKOUT) from the output terminal Y of the multiplexer 27.

Accordingly, the output clock signal (CLKOUT) changes to the master clock signal (inCLK0), the first clock signal (inCLK1), the second clock signal (inCLK2), the third clock signal (inCLK3) corresponding to the data area of the IC's 14, 15, 16, and 17, respectively.

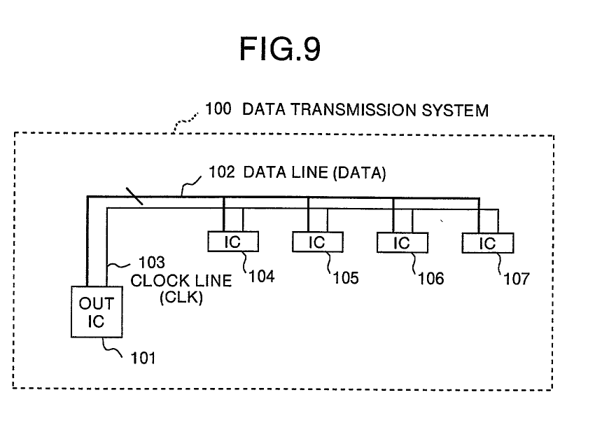

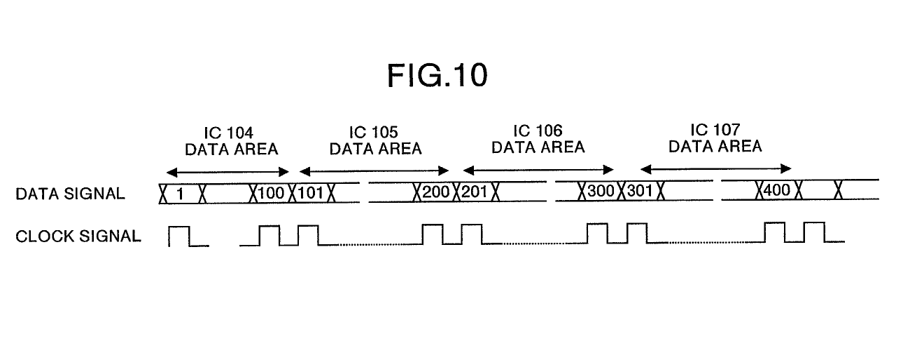

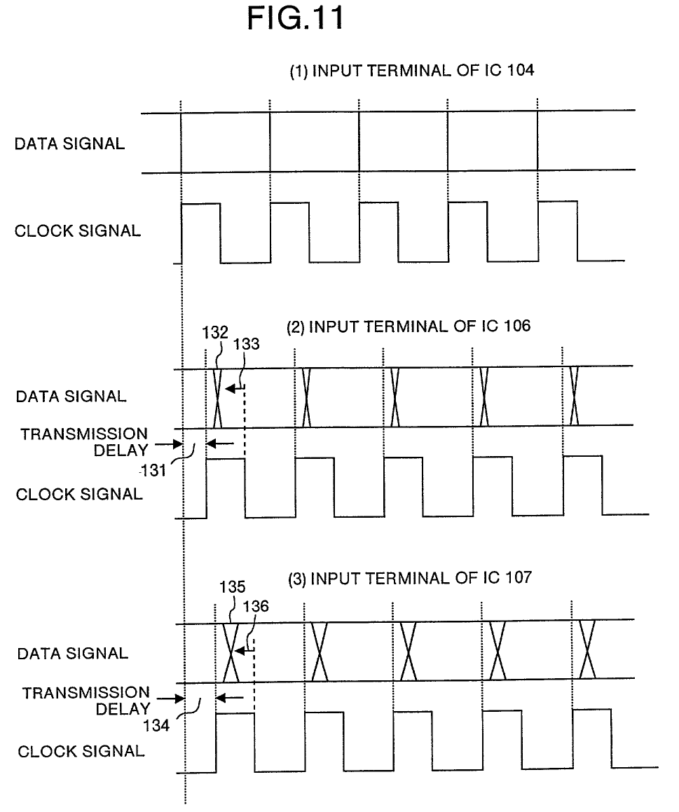

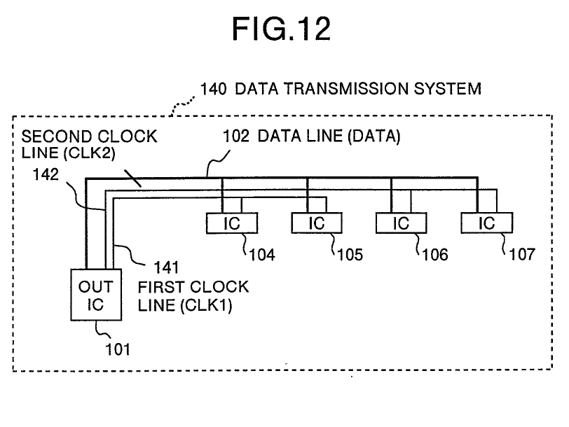

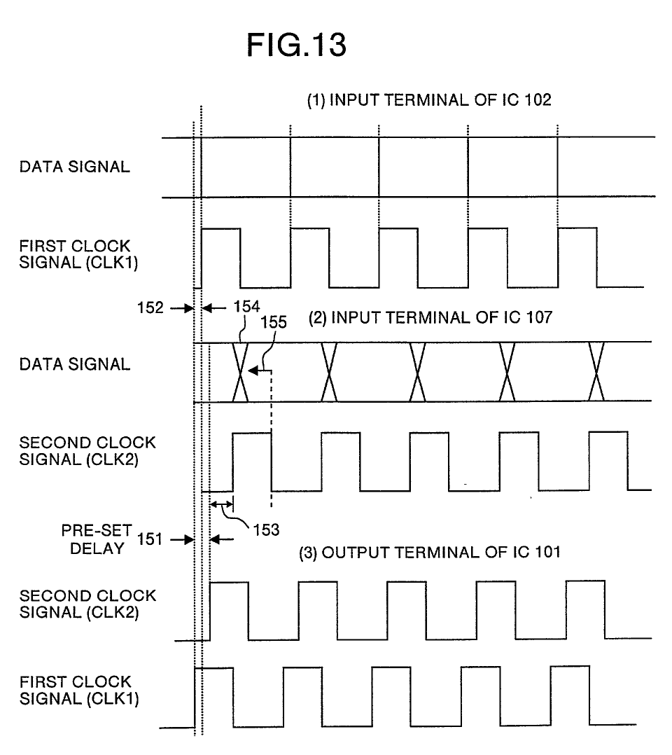

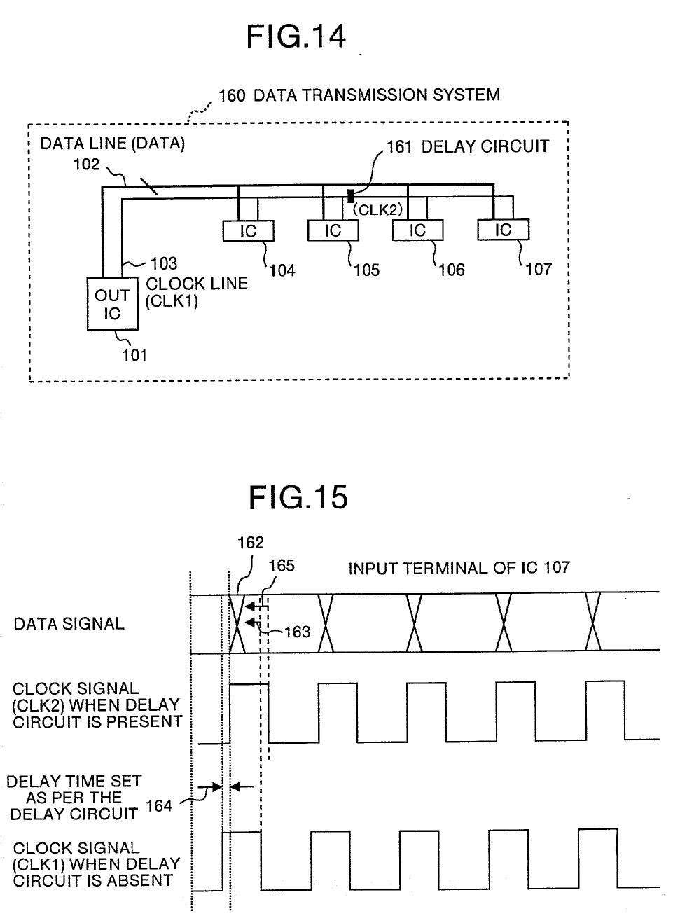

FIG. 4 shows the relationship between the timing of data signal and clock signal when the output clock signal (CLKOUT) shown in FIG. 3 is transmitted to each IC. A pre-process CLK signal is the clock signal output by the conventional OUTIC 101 shown in FIG. 9. A post-process CLK signal is the clock signal output by the OUTIC 11 according to the first embodiment.

(1) Regarding the input terminal of the IC 14: Since a signal same as the master clock signal (inCLK0) is input, the pre-process CLK signal and the post-process CLK signal are same. As the IC 14 is close to the OUTIC 11, the relationship between the timings of data signal and clock signal at the input terminal is good.

(2) Regarding the input terminal of the IC 16: If the conventional pre-process CLK signal is used, it reaches the input terminal of the IC 16 through the transmission path with a certain delay time 41. Consequently, considerable time lag between a setup time 42 of the data signal, its hold time 43 and the pre-process CLK signal is observed. The IC 16 is second far most IC to the OUTIC 11.

However, as the post-process CLK signal is the second clock signal (inCLK2) which is delayed with two time units, it reaches the input terminal of the IC 16 with a delay time 44 which is longer than the delay time 41. Therefore, the time lag between the setup time 42 of data signal, the hold time 45 and the post-process CLK signal is not very significant.

(3) Regarding the input terminal of the IC 17: If the conventional pre-process CLK signal is used, it reaches the input terminal of the IC 17 through the transmission path with a certain delay time 46. Consequently, the IC 17 which is farthest from the OUTIC 11. As a result, the time lag between the setup time 46 of the data signal, the hold time 47 and the pre-process CLK signal is relatively high and can exceed the constraint limits of the IC 17.

However, as the post-process CLK signal is the third clock signal (inCLK3) which is delayed by three time units, it reaches the input terminal of the IC 17 with a delay time of 48 which is longer than the delay time 46. Therefore, the time lag between the setup time 47 of data signal, the hold time 50 and the post-process CLK signal is within the constraint of the IC 17.

The transition period of the wave forms in the input terminal of the IC 14 with a short wiring circuit may get prolonged due to reflection or interference (cross talk) of the data signals when the number of data bits is large. In such a case, the data signal at the input terminal of the IC 14 is delayed longer than the data signal at the input terminal of the IC 17. In other words, a clock signal that is less delayed than that of the IC 14 becomes necessary at the input terminal of the IC 17. In this embodiment such requirements can be easily fulfilled. (Refer to FIG. 5)

In FIG. 5, (6) the selection signal S[0:1] has a value of 3 corresponding to the data area of the IC 14, 2 corresponding to the data area of the IC 15, 1 corresponding to the data area of the IC 16, and 0 corresponding to the data area of the IC 17. The selection signal S[0:1] is input into the selector terminal ST of the multiplexer 27. As a result, in multiplexer 27 signals are selected in the order of the signals input into the input terminals A3, A2, A1, A0 and the selected clock signals are output as output clock signals (CLKOUT) from output terminal Y.

Therefore the output clock signal (CLKOUT) changes to the third clock signal (inCLK3) with the highest delay, the second clock signal (inCLK2) with the second highest delay, the first clock signal (inCLK1) with the second lowest delay, the master clock signal (inCLK0) with the lowest delay, corresponding to the data area of the IC's 14, 15, 16, and 17, respectively.

In this first embodiment, the OUTIC is configured to output a plurality of clock signals with differing phases based on selection of transmission timing. As a result, depending on the location of each IC, clock signals can be transmitted with different time lags. It is also possible to transmit clock signals to each IC with appropriate phase difference without regard to the location of the IC but depending on the data transmission status.

FIG. 6 is a block diagram showing a configuration of the OUTIC in the semiconductor integrated circuit according to the second embodiment of this invention. In FIG. 6, the components similar to those shown in FIG. 2 have been provided with the same legends. In the first embodiment, an example of setting a delay for each receiver semiconductor integrated circuit (IC) is explained. On the other hand, the second embodiment assume a case which does not necessarily involve phase change of clock signal to each IC.

As shown in FIG. 6, the second embodiment has a structure such that the multiplexer 27 shown in FIG. 2 is replaced with a multiplexer 32, and a multiplexer 32 is newly added to the configuration shown in FIG. 2. The rest of the configuration is same as that shown in FIG. 2.

The multiplexer 31 is supplied with various switching patterns signals S0[0:1], S1[0:1], S2[0:1]. Depending on the external selection signal 33, the multiplexer 31 selects one of the switching pattern signals and outputs the selected switching pattern signal 34. The switching pattern signal 34 is input into a selector terminal ST of the multiplexer 32.

Depending on the switching pattern signal 34 input into the selector terminal ST, the multiplexer 32 selects a signal input into the terminals A0, A1, A2 or A3 as follows. For example, when the switching pattern signal 34 is S[0:1], the multiplexer 32 is made to select the signal input into the terminal A1 corresponding to the data area of the IC's 14 and 15 and the signal input into the terminal A3 in the data area of the IC's 16 and 17. In this way, the multiplexer selects the appropriate combination of input terminals A0, A1, A2, A3, depending on the switching pattern signal 34.

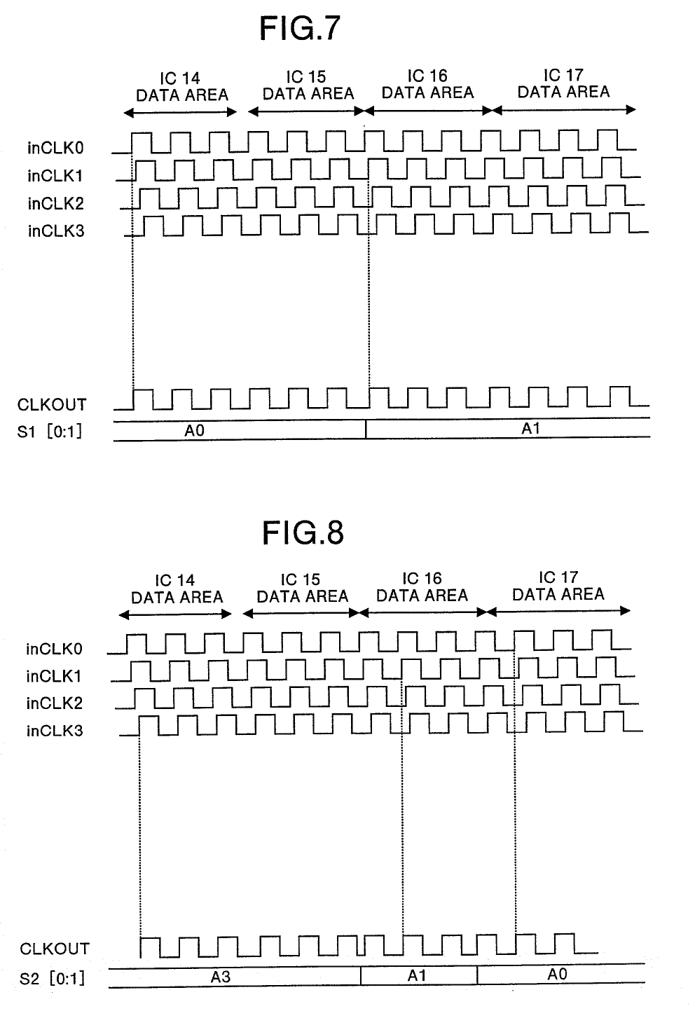

The operation of the OUTIC according to the second embodiment will be explained with the help of FIG. 7 and FIG. 8. FIG. 7 is the first time chart that explains the relation between the generated clock signals, output clock signals and the selected signals when the switching pattern signal 34 is S1[0:1]. FIG. 8 is the second time chart that explains the relation between the generated clock signals, output clock signals and the selected signals when the switching pattern signal 34 is S2[0:1].

In both FIG. 7 and FIG. 8, inCLK0 represents the internally generated master clock signal. inCLK1 is the first clock signal output from the delay element 21, obtained by delaying the master clock signal by one time unit. inCLK2 is the second clock signal output from the delay elements 22 and 23, obtained by delaying the master clock signal by two time units. inCLK3 is the third clock signal output from the delay elements 24, 25, and 26, obtained by delaying the master clock signal by three time units. The multiplexer 32 therefore has four clock signals of different phases.

As shown in FIG. 7, when the switching pattern signal 34 is S1[0:1], in the multiplexer 31, the signal input into the terminal A0 corresponding to the data area of the IC's 14 and 15, and the signal input into the terminal A1 corresponding to the data area of the IC's 16 and 17 are selected. Consequently, output clock signal (CLKOUT) corresponding to the data area of the IC's 14 and 15 would be the master clock signal (inCLK0) and corresponding to the data area of the IC's 16 and 17 would be the first clock signal (inCLK1). As a result, the IC's 14 and 15 will retrieve data from their data area according to the master clock signal (inCLK0), and the IC's 16 and 17 will retrieve data from the corresponding data area according to the first clock signal (inCLK1). In this example, the number of phase changes is 2. Any number of phase changes can be selected in this manner.

As shown in FIG. 8, when the switching pattern signal 34 is S2[0:1], in the multiplexer 31, the signal input into the terminal A3 corresponding to the data area of the IC's 14 and 15, the signal input into the terminal A1 corresponding to the data area of the IC 16, and the signal input into the terminal A0 corresponding to the data area of the IC 17 are selected. Consequently, output clock signal (CLKOUT) corresponding to the data area of the IC′ 14 and 15 would be the third clock signal (inCLK3), corresponding to the data area of the IC 16 it would be the first clock signal (inCLK1), and corresponding to the data area of the IC 17 it would be the master clock signal (inCLK0).

As a result, the IC's 14 and 15 will retrieve data from their data area according to the master clock signal (inCLK3), the IC 16 will retrieve data from its data area according to the first clock signal (inCLK1), and the IC 17 will retrieve data from its data area according to the master clock signal (inCLK0). In this example, IC 14 and IC 15 are in the same phase whereas the phases of the IC 16 and IC 17 are different. Any number of phase changes in any phase difference combination can be selected in this manner.

As the actual signal delay cannot be determined unless the electronic gadget is completely manufactured, the substrate designers of data transmission system of the electronic gadget use a rather cut and dried method of introducing the resistance, condenser, inductor, noise filter, etc. in the transmission circuit and simultaneously verifying the waveform of the product, thereby adjusting the delay.

According to the second embodiment, delay-inducing mechanisms that delay output clock signals are provided in the output semiconductor integrated system (OUTIC 11). Thus, the delay can be controlled and the time can be adjusted with ease. The time adjustment can be made further simpler if the first and second embodiments are used together. FIG. 2 and FIG. 6 show three types of delays of output clock signals. However, the selection choices of paths inducing delays can be increased with facility for selecting a wide range of delay values.

As explained in detail above, according to one aspect of this invention, there is provided a phase changing unit which supplies the clock signals with differing phases to each of the receiver semiconductor integrated circuits.

According to another aspect of this invention, there is provided a group phase changing unit which supplies clock signals with differing phases to each group of receiver semiconductor integrated circuits.

According to still another aspect of this invention, there are provided a phase changing unit which supplies clock signals with differing phases to each of the receiver semiconductor integrated circuits, and a group phase changing unit which supplies the clock signals with differing phases to each group of receiver semiconductor integrated circuits.

Consequently, the relative time of the clock signals and data signals of the input terminals of the receiver semiconductor integrated circuits that are connected in a parallel manner to the clock signal line and the data signal line can be adjusted with ease. Further, substrate area need not be a consideration when actually assembling the unit as it is not required to break the clock line. Also, since there is no need for providing a delay circuit(s) in the transmission path, the number of components required in the assembly is considerably reduced, thereby reducing the gadget size and the cost.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A semiconductor integrated circuit which transmits clock signals and data signals to a plurality of receiver semiconductor integrated circuits through a common clock signal line and a data signal line, the semiconductor integrated circuit comprising:
a phase changing unit which supplies clock signals with differing phases to each of the receiver semiconductor integrated circuits.

2. The semiconductor integrated circuit according to claim 1, wherein the phase changing unit includes
a delay unit which delays an internally-generated master clock signal in a stepped manner to thereby generate the clock signals with differing phases; and
a selection-output unit which sequentially selects a signal from the clock signals with differing phases and outputs the selected signal.

3. The semiconductor integrated circuit according to claim 2, wherein when selecting a signal from the clock signals with differing phases, the selection-output unit makes the selection based on an ascending or descending order of the delay provided to the clock signals.

4. A semiconductor integrated circuit which transmits clock signals and data signals to a plurality of receiver semiconductor integrated circuits through a common clock signal line and a data signal line, the semiconductor integrated circuit comprising:
a group phase changing unit which supplies clock signals with differing phases to each group of receiver semiconductor integrated circuits, wherein the group of receiver semiconductor integrated circuits including a specific number of the receiver semiconductor integrated circuits.

5. A semiconductor integrated circuit according to claim 4, wherein the group phase changing unit includes
a delay unit which delays an internally-generated master clock signal in a stepped manner to thereby generate the clock signals with differing phases; and
a selection-output unit which sequentially selects a signal from the clock signals with differing phases and outputs the selected signal for a specific number of times.

6. A semiconductor integrated circuit which transmits clock signals and data signals to a plurality of receiver semiconductor integrated circuits through a common clock signal line and a data signal line, the semiconductor integrated circuit comprising:
a phase changing unit which supplies clock signals with differing phases to each of the receiver semiconductor integrated circuits; and
a group phase changing unit which supplies the clock signals with differing phases to each group of receiver semiconductor integrated circuits, wherein the group of receiver semiconductor integrated circuits including a specific number of the receiver semiconductor integrated circuits.

7. The semiconductor integrated circuit according to claim 6,
a delay unit which delays an internally-generated master clock signal in a stepped manner to thereby generate the plurality of clock signals with differing phases;
a first selection-output unit which sequentially selects a signal from the clock signals with differing phases and outputs the selected signal; and
a second selection-output unit which sequentially selects a signal from the clock signals with differing phases and outputs the selected signal for a specific number of times.
